(19) United States
(12) Patent Application Publication
(10) Pub. No.: US 2025/0183332 A1
(43) Pub. Date: Jun. 5, 2025

(54) FUEL CELL STACK CURRENT COLLECTOR

(71) Applicant: HYDROGENICS CORPORATION, Mississauga (CA)

(72) Inventors: Rainey Yu WANG, Richmond Hill (CA); Nathaniel Ian JOOS, Toronto (CA); Qing NI, Mississauga (CA); Salvatore RANIERI, Etobicoke (CA)

(21) Appl. No.: 18/954,067

(22) Filed: Nov. 20, 2024

Related U.S. Application Data
(60) Provisional application No. 63/604,696, filed on Nov. 30, 2023.

(51) Int. Cl. H01M 8/0267; H01M 8/0258; H01M 8/0271; H01M 8/10

(52) U.S. Cl. CPC H01M 8/0267; H01M 8/0258; H01M 8/0271; H01M 2008/1095; H01M 2250/20

(57) ABSTRACT

The present disclosure relates to systems and methods of improving fuel cell stack performance by preventing corrosion and heat loss. The present disclosure describes embodiments of end plates positioned in a fuel cell stack that are configured to increase fuel cell stack efficiency.

### CROSS-REFERENCE TO RELATED APPLICATIONS

This nonprovisional application claims the benefit and priority, under 35 U.S.C. § 119 (e) and any other applicable laws or statutes, to U.S. Provisional Application Ser. No. 63/604,696 filed on Nov. 30, 2023, the entire disclosure of which is hereby expressly incorporated herein by reference.

### TECHNICAL FIELD

The present disclosure relates to systems and methods of improving fuel cell stack performance by preventing corrosion and heat loss.

### BACKGROUND

Vehicles and/or powertrains use fuel cell systems comprising fuel cells and/or fuel cell stacks for their power needs. The fuel cell system produces electrical energy in the form of direct current (DC) from electro-chemical reactions that take place in the fuel cell. The fuel cell system may be powered by hydrogen or by a hydrogen-rich, conventional fuel, such as methanol, gasoline, diesel, or gasified coal.

The typical fuel cell is comprised of many assemblies compressed and bound into a stack. The typical fuel cell includes a multi-component membrane electrode assembly (MEA) that has an anode, a cathode, and an electrolyte. Typically, the anode, the cathode, and the electrolyte of the membrane electrode assembly (MEA) are configured in a multi-layer arrangement that enables the electrochemical reaction to consume hydrogen. The fuel cell typically includes a gas diffusion layer (GDL) positioned on both sides of the MEA. Bipolar plates (BPP) often reside on either side of the GDLs and are configured to separate the individual electrolytic cells of the stack from one another.

Fuel cell systems reject heat and require active liquid cooling on a regular basis. One or more piping components, such as pipes, valves, and joint connectors, are coupled to the fuel cell to channel fluids, such as the fuel, oxidant, coolant, and byproducts into and away from the fuel cells. The temperature of the coolant entering the fuel cell system is maintained within a certain range based on the required operating conditions.

The fuel cell stack usually includes a terminal structure comprising a starter plate on either end of the stack. Each starter plate has a geometry that enables the reactants to flow on the side of the plate that faces the fuel cell. The starter plate also enables the coolant to flow in the interior channels of the stack. The bipolar plates made of graphite-based materials have problems associated with permeation because the fluid (reactants or coolant) tends to permeate through the starter plates and exit the fuel cell stack. As a result, during operation of the fuel cell system, permeating coolant causes corrosion and electrical shorting hazard in the fuel cell stacks. Additionally, during operation, the fuel cells closest to the starter plates tend to lose heat faster than the fuel cells in the middle of the stack. Such heat loss lowers the overall performance of the fuel cell stack.

The present disclosure is directed to systems and methods of improving the efficiency of the fuel cell system by preventing coolant permeation and heat loss in the fuel cell stack.

### SUMMARY

Embodiments of the present disclosure are included to meet these and other needs.

In one aspect, the disclosure is directed to a fuel cell stack comprising a first terminal structure including an end plate configured to provide mechanical clamping, an insulator positioned adjacent to the end plate and surrounding a current collector on three sides, a starter plate positioned adjacent to the current collector, and a blank plate positioned in between the starter plate and the current collector, a second terminal structure configured similarly to the first terminal structure, and one or more bipolar plates comprising of a first sub-plate bonded to a second sub-plate positioned in between the first and second terminal structures.

In some embodiments, the starter plate may have the same configuration as the bipolar plate. In some embodiments, the blank plate may be configured to prevent coolant permeation from the starter plate to the current collector. In some embodiments, the starter plate may be comprised of graphite.

In some embodiments, the fuel cell stack may further comprise an intermediate sheet positioned between the first the starter plate and the blank plate. In some embodiments, the intermediate sheet may comprise an electrically conductive or corrosion resistant material. In some embodiments, the intermediate sheet may comprise a compressible material. In some embodiments, a seal may be positioned adjacent to the starter plate and the intermediate sheet is configured to fill a gap created by the seal.

In some embodiments, the starter plate may include a reactant flow field and a reactant flowing through the reactant flow field may not be a constituent of a fuel cell reaction in the fuel cell stack. In some embodiments, the starter plate may further include a coolant flow field and the reactant flowing through the reactant flow field may remove any coolant that permeates out of the coolant flow field.

In another aspect, the disclosure is directed to a terminal structure of a fuel cell stack comprising an end plate configured to provide mechanical clamping, an insulator positioned adjacent to the end plate and surrounding a current collector on three sides, a starter plate positioned adjacent to the current collector, and a blank plate positioned in between the starter plate and the current collector.

In some embodiments, the starter plate may have the same configuration as a bipolar plate positioned adjacent to the starter plate. In some embodiments, the blank plate may be configured to prevent coolant permeation from the starter plate to the current collector. In some embodiments, the starter plate may be comprised of graphite.

In some embodiments, the terminal structure may further comprise an intermediate sheet positioned between the first the starter plate and the blank plate. In some embodiments, the intermediate sheet may comprise an electrically conductive or corrosion resistant material. In some embodiments, the intermediate sheet may comprise a compressible material.

In some embodiments, a seal may be positioned adjacent to the starter plate and the intermediate sheet is configured to fill a gap created by the seal. In some embodiments, the starter plate may include a reactant flow field and a reactant flowing through the reactant flow field may not be a constituent of a fuel cell reaction in the fuel cell stack. In some embodiments, the starter plate may further include a coolant flow field and the reactant flowing through the reactant flow field may remove any coolant that permeates out of the coolant flow field.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of a bonded assembly of two individual sub-plates forming a bipolar plate;

FIG. 3 is an illustration of a fuel cell stack including a terminal structure positioned on both ends of the stack;

FIG. 4 is an illustration of a fuel cell stack including a blank plate in the terminal structure positioned on both ends of the stack; and

FIG. 5 is an illustration of a fuel cell stack including a seal on either side of the blank plate illustrated in FIG. 4.

### DETAILED DESCRIPTION

The present disclosure provides systems and methods of improving fuel cell stack performance by preventing corrosion and heat loss. The present disclosure is directed to the use of blank plates in the terminal structures of a fuel cell stack.

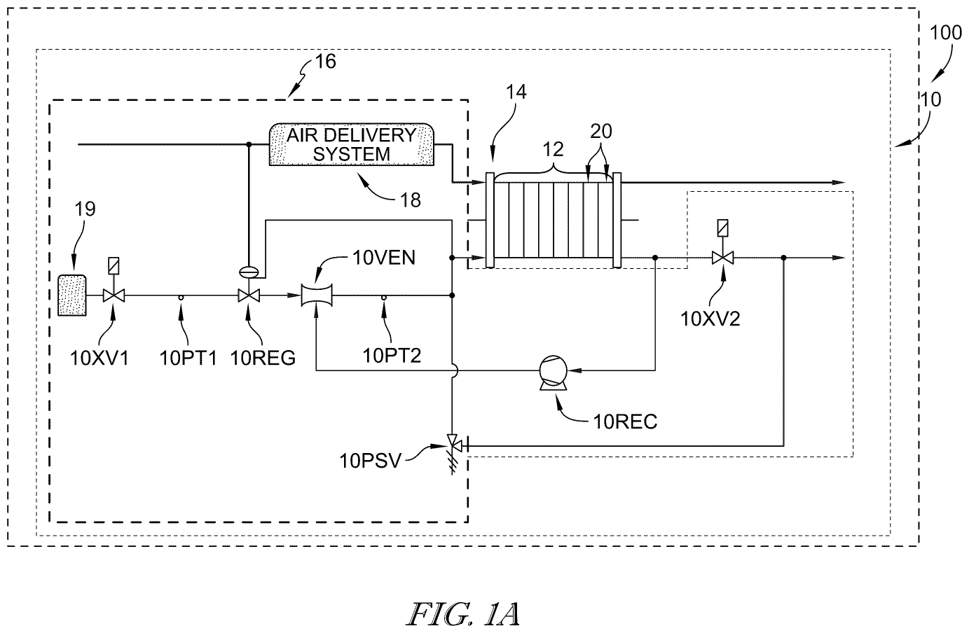

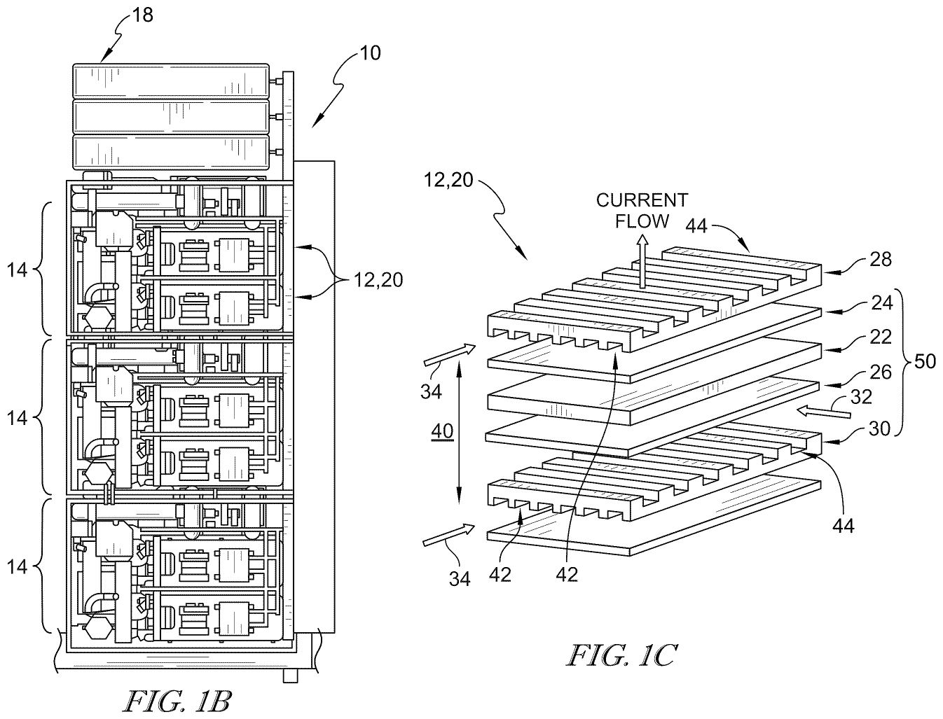

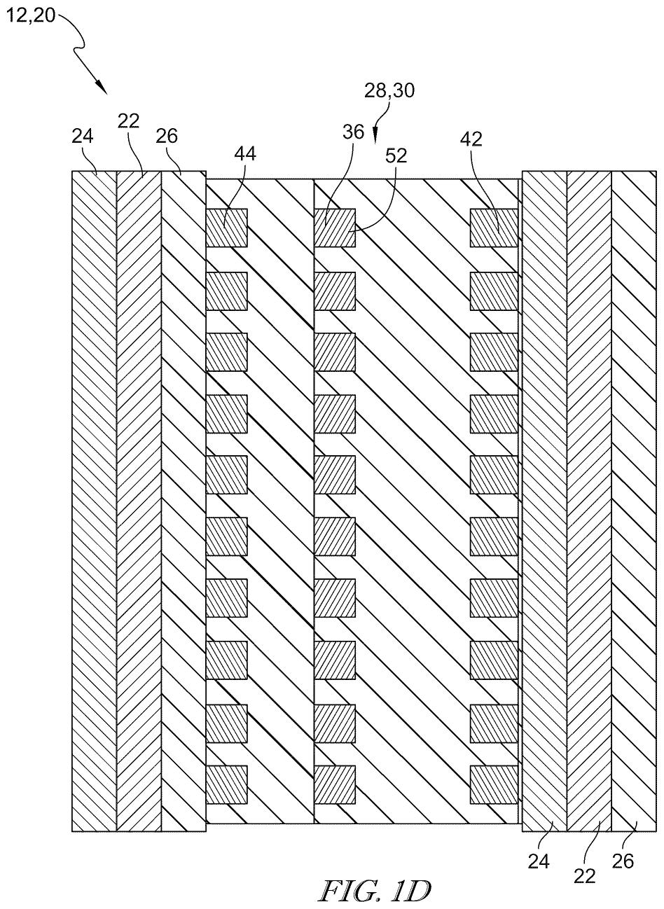

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, valves, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and gas diffusion layers (GDL) 24, 26 on both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

Referring to FIGS. 1C and 1D, the bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel or hydrogen flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or regulate one or more reactants 32, 34 within their respective pathways 44, 42 and maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments (see FIG. 1A), the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments (see FIG. 1A), the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck, trains, forklifts, or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

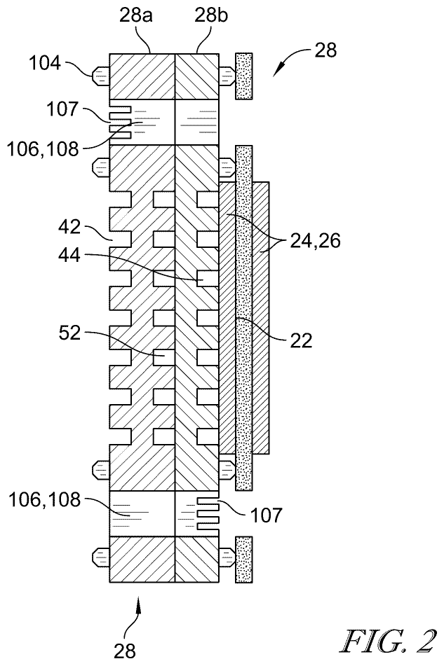

As shown in in FIG. 2, the bipolar plate (BPP) 28 is configured as a bonded assembly of two individual sub-plates, a cathode sub-plate 28a and an anode sub-plate 28b. The two individual sub-plates, the cathode sub-plate 28a and the anode sub-plate 28b, may be attached or welded together. The cathode sub-plate 28a and the anode sub-plate 28b are bonded to form a fluidic seal. Each sub-plate 28a, 28b has flow fields 44, 42 on the exterior surfaces for fuel 32 (e.g., hydrogen 19) and/or air 34. The two sub-plates 28a, 28b also form an internal coolant flow field 52 for the coolant 36.

In most applications, the bipolar plates (BPP) 28 are made of either graphite-based material or metal-base materials. In some embodiments, the bipolar plates (BPP) 28 may be comprised of composite materials like carbon polymers. The bipolar plate (BPP) 28 may be inherently porous allowing the coolant 36 to permeate from the coolant flow field 52 into the fuel flow field 44 and/or into the air flow field 42.

Each bipolar plate (BPP) 28 also has an opening 108, which, when connected with the similar openings of other bipolar plates (BPP) 28 and the MEA 22 forms a manifold 106. The bipolar plate (BPP) 28 has an inlet and outlet manifold 106 for the input and exit of fuel 32 (e.g., hydrogen 19), air 34, and coolant 36. Each manifold 106 also has flow channels 107, which connect in-plane to the flow fields 42, 44, 52. The manifolds 106 and flow channels 107 are enclosed by seals 104.

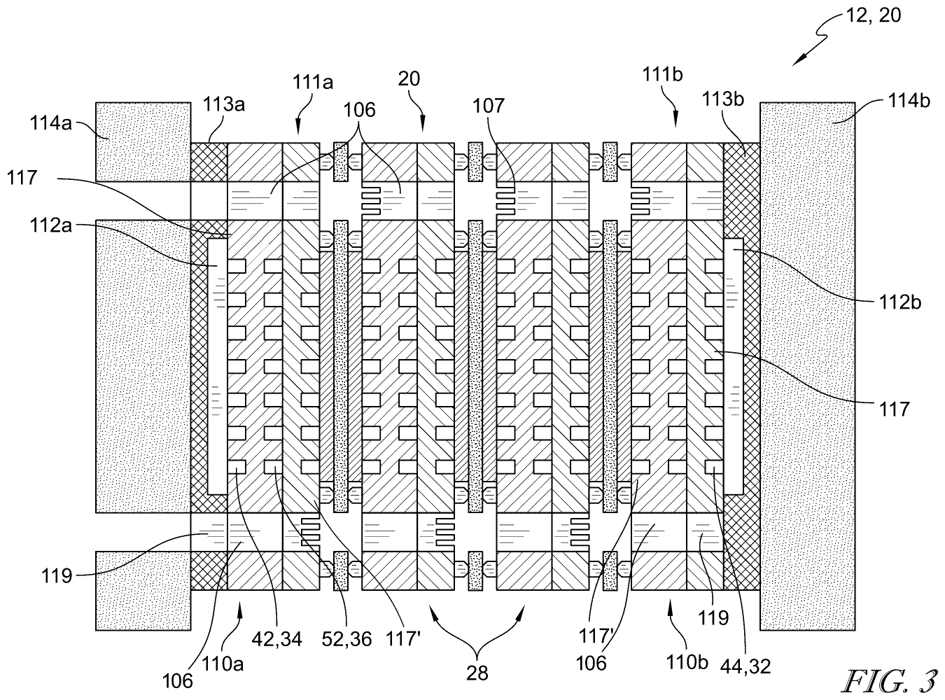

As shown in FIG. 3, the typical fuel cell stack 12 includes terminal structures 110a, 110b on both ends of the stack 12. Each terminal structure 110a, 110b comprises a starter plate 111a, 111b, a current collector 112a, 112b, an insulator 113a, 113b, and an end plate 114a, 114b. The insulators 113a, 113b surround the current collector 112a, 112b on three sides. The fourth side of the current collectors 112a, 112b is positioned adjacent to the starter plates 111a, 111b.

The starter plates 111a, 111b have the same geometry and flow channels as the bipolar plate (BPP) 28 found within the rest of the fuel cell stack 12 with one exception. There are no channels 107 within the manifold 106 on an outside side 117 of the starter plates 111a, 111b. The outside side 117 faces away from the center of the fuel cell stack 12. Because of this difference, there is no reactant flow on the outside side 117 of the starter plate 111a, 111b.

However, there is still reactant flow on an inside side 117′ of the starter plates 111a, 111b. The inside side 117′ faces the center. Additionally, there is coolant 36 flow in the coolant flow fields 52 of the starter plates 111a. 111b.

Still referring to FIG. 3, the current collectors 112a, 112b are configured to harvest electricity generated from the fuel cell reactions and transmit the electricity for user application. In some embodiments, the current collectors 112a, 112b are comprised of aluminum substrates with a conductive coating. The insulators 113a, 113b provide electrical isolation, while the end plates 114a, 114b provide mechanical clamping or enforcement of the stack 12 via additional fasteners (not shown). On each end, the insulator 113a and end plate 114a have port openings 119 that align with the manifold 106 on the bipolar plates (BPP) 28 and the starter plates 111a, 111b. The port openings 119 provide an inlet and/or outlet for fuel 32 (e.g., hydrogen 19), air 34, and coolant 36 to enter and exit the fuel cell stack 12.

During fuel cell stack 12 operation, the coolant 36 flowing in the flow fields 52 in the starter plate 111a, 111b may slowly permeate into the reactant flow fields 42, 44 in the starter plates 111a, 111b. The coolant 36 permeating through the starter plates 111a, 111b can contact the current collector 112a, 112b and cause corrosion and/or electrical shorting.

Further, the fuel cells 20 closest to the terminal structures 110a, 110b tend to lose heat faster than other fuel cells 20 positioned in the middle of the fuel cell stack 12. Consequently, the fuel cells 20 closest to the terminal structures 110a, 110b are colder and are more prone to liquid water flooding. Therefore, temperature loss in the fuel cells 20 closest to the terminal structures 110a, 110b may lower the overall performance of the stack 12.

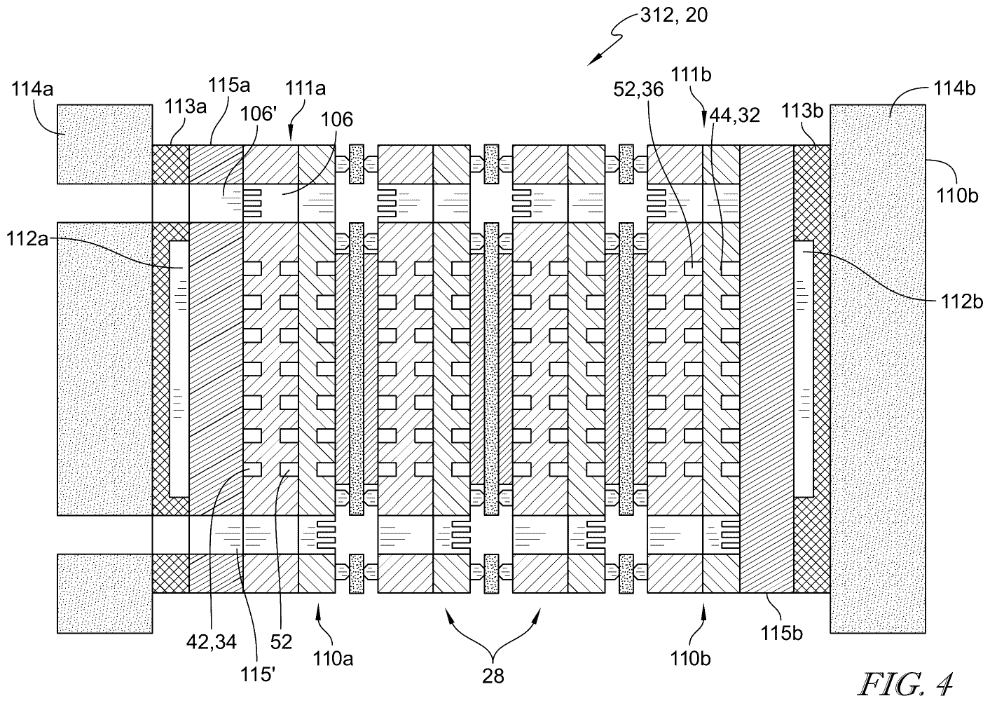

As shown in FIG. 4, in one embodiment, a fuel stack 312 includes the terminal structures 110a, 110b on both ends of the stack 12. Each terminal structure 110a, 110b comprises the starter plate 111a, 111b, the current collector 112a, 112b, the insulator 113a, 113b, and the end plate 114a, 114b. The fuel stack 312 further includes blank plates 115a, 115b to prevent the above-described coolant 36 permeation and heat loss. The blank plates 115a, 115b are positioned between the current collectors 112a, 112b and the starter plates 111a, 111b so that any coolant 36 permeating through the starter plates 111a, 111b is blocked from contacting the current collector 112a, 112b. The blank plates 115a, 115b serve as a barrier to the coolant 36 making contact with the current collectors 112a, 112b.

As shown in FIG. 4, in some embodiments, fuel 32 (e.g., hydrogen 19) or air 34 is allowed to flow through the flow fields 44, 42 in the starter plates 111a, 111b adjacent to the blank plates 115a, 115b. Fuel 32 (e.g., hydrogen 19) or air 34 flow in the starter plates 111a, 111b allows for the removal of any coolant 36 that may have permeated from the coolant flow fields 52 into the starter plates 111a, 111b. Therefore, in such embodiments, the starter plates 111a, 111b may have the exact configuration as the regular bipolar plate (BPP) 28 positioned in the center of the fuel cell stack 312. The fuel cell stack 312 can have additional fuel (e.g., hydrogen) and air flow fields 44, 42 beyond the first or last bipolar plate (BPP) 28. However, the fuel 32 (e.g., hydrogen 19) or air 34 passing in these end flow fields 44, 42 located in the starter plates 111a, 111b may not participate in fuel cell reactions.

As shown in FIG. 4, the blank plates 115a, 115b may have the same outside shape as the bipolar plates (BPP) 28 positioned in the center of the fuel cell stack 312. On an outside side 115′ of the blank plates 115a, 115b where the reactant 32, 34 or the coolant 36 is supplied, the blank plate 115a may comprise a manifold opening 106′ that aligns with the manifold 106 of the starter plates 111a, 111b and the bipolar plates (BPP) 28. The blank plates 115a, 115b may be comprised of metal, graphite, graphite composite, and/or any other electrically conductive material that may not corrode in the presence of liquid and/or electrical current.

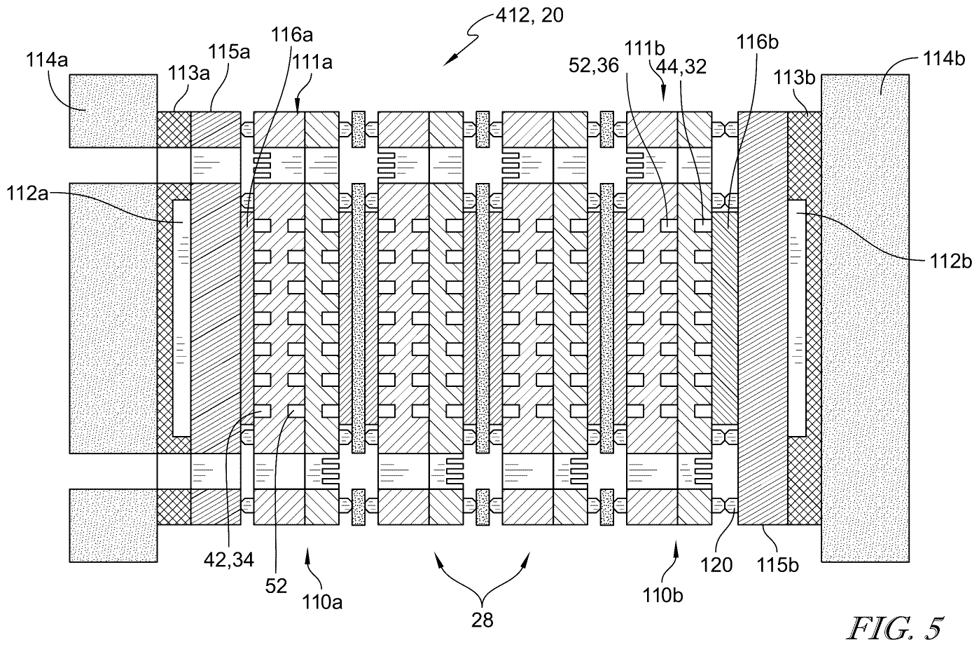

In one embodiment, as shown in FIG. 5, a fuel cell stack 412 may include an additional seal 120. The additional seal 120 may be added on either side of the blank plate 115a, 115b, or the starter plates 111a, 111b, or both, to ensure adequate sealing in the fuel cell stack 412. The seal 120 may be positioned around the manifolds 106 where fuel 32 (e.g., hydrogen 19), air 34, and/or coolant 36 enters or exits the fuel cell stack 412. In one embodiment, as shown in FIG. 5, an intermediate sheet 116a, 116b may be added between the starter plates 111a, 111b and the blank plate 115a, 115b.

The intermediate sheet 116a, 116b may comprise an electrically conductive and/or corrosion resistant material. The intermediate sheet 116a, 116b may comprise a compressible material, such as carbon paper, woven carbon fiber sheet, and/or flexible graphite. The intermediate sheet 116a, 116b may be used to fill the gap created when the seal 120 is positioned adjacent to the starter plates 111a, 111b. The intermediate sheet 116a, 116b may be chosen such that upon assembly, the thickness of the intermediate sheet 116a, 116b matches the compressed thickness of the seal 120.

During the operation of the fuel cell stack 412, the coolant 36 in the flow fields 52 may permeate through the starter plates 111a, 111b toward the hydrogen or air flow fields 42, 44. However, the permeated coolant 36 may be blocked by the blank plates 115a, 115b and/or the intermediate sheets 116a and 116b from reaching the current collects 112a, 112b. Furthermore, in some embodiments, fuel 32 (e.g., hydrogen 19) or air 34 may flow through the flow fields 44, 42 bounded by the blank plates 115a, 115b or the intermediate sheets 116a, 116b. The flow of fuel 32 (e.g., hydrogen 19) or air 34 may remove any permeated coolant 36.

Also, the addition of the blank plates 115a, 115b and/or the intermediate sheets 116a and 116b may provide thermal insulation, so that the temperature of the first and last fuel cells 20 of the fuel cell stack 312, 412 is maintained at a temperature similar to the temperature of the other fuel cells 20 located in the interior of the fuel cell stack 412. Therefore, such a configuration improves the efficiency and the overall performance of the fuel cell 312.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell stack comprising:
a first terminal structure including:
an end plate configured to provide mechanical clamping,
an insulator positioned adjacent to the end plate and surrounding a current collector on three sides,
a starter plate positioned adjacent to the current collector, and
a blank plate positioned in between the starter plate and the current collector,
a second terminal structure configured similarly to the first terminal structure, and
one or more bipolar plates comprising a first sub-plate bonded to a second sub-plate positioned in between the first and second terminal structures.

2. The fuel cell stack of claim 1, wherein the starter plate has the same configuration as the bipolar plate.

3. The fuel cell stack of claim 1, wherein the blank plate is configured to prevent coolant permeating from the starter plate to the current collector.

4. The fuel cell stack of claim 1, wherein the starter plate is comprised of graphite.

5. The fuel cell stack of claim 1, further comprising an intermediate sheet positioned between the starter plate and the blank plate in the first and the second terminal structures.

6. The fuel cell stack of claim 5, wherein the intermediate sheet comprises an electrically conductive or corrosion resistant material.

7. The fuel cell stack of claim 5, wherein the intermediate sheet comprises a compressible material.

8. The fuel cell stack of claim 5, wherein a seal is positioned adjacent to the starter plate, and wherein the intermediate sheet is configured to fill a gap created by the seal.

9. The fuel cell stack of claim 1, wherein the starter plate includes a reactant flow field, and wherein a reactant flowing through the reactant flow field is not a constituent of a fuel cell reaction in the fuel cell stack.

10. The fuel cell stack of claim 9, wherein the starter plate further includes a coolant flow field, and wherein the reactant flowing through the reactant flow field is configured to remove any coolant that permeates out of the coolant flow field of the starter plate.

11. A terminal structure of a fuel cell stack comprising:
an end plate configured to provide mechanical clamping,
an insulator positioned adjacent to the end plate and configured to surround a current collector on three sides,
a starter plate positioned adjacent to the current collector, and
a blank plate positioned in between the starter plate and the current collector.

12. The terminal structure of claim 11, wherein the starter plate has the same configuration as a bipolar plate positioned adjacent to the starter plate.

13. The terminal structure of claim 11, wherein the blank plate is configured to prevent coolant permeating from the starter plate to the current collector.

14. The terminal structure of claim 11, wherein the starter plate is comprised of graphite.

15. The terminal structure of claim 11, further comprising an intermediate sheet positioned between the starter plate and the blank plate.

16. The terminal structure of claim 11, wherein the intermediate sheet comprises an electrically conductive material or a corrosion resistant material.

17. The terminal structure of claim 16, wherein the intermediate sheet comprises a compressible material.

18. The terminal structure of claim 11, wherein a seal is positioned adjacent to the starter plate and the intermediate sheet is configured to fill a gap created by the seal.

19. The terminal structure of claim 11, wherein the starter plate includes a reactant flow field, and wherein a reactant flowing through the reactant flow field is not a constituent of a fuel cell reaction in the fuel cell stack.

20. The terminal structure of claim 19, wherein the starter plate further includes a coolant flow field, and wherein the reactant flowing through the reactant flow field is configured to remove any coolant that permeates out of the coolant flow field of the starter plate.
